(19) United States
(12) Patent Application Publication
(10) Pub. No.: US 2015/0186688 A1
(43) Pub. Date: Jul. 2, 2015

(54) READER AND INFORMATION PROCESSING SYSTEM USING THE SAME

(71) Applicants: Fu Tai Hua Industry (Shenzhen) Co., Ltd., Shenzhen (CN); HON HAI PRECISION INDUSTRY CO., LTD., New Taipei (TW)

(72) Inventors: Zong-Yuan SUN, New Taipei (TW); Da-Hua XIAO, Shenzhen (CN)

(21) Appl. No.: 14/557,887

(22) Filed: Dec. 2, 2014

(30) Foreign Application Priority Data
Dec. 30, 2013 (CN) 201310742072.9

(51) Int. Cl. G06K 7/10; G06K 7/01

(52) U.S. Cl. CPC G06K 7/10207; G06K 7/01; G06K 7/10297

(57) ABSTRACT

A reader which can be connected to a separate portable device and reads and gathers individual amounts of data includes a reading unit, an input unit, a processor, and a first communication unit. The reading unit reads an information carrier such as a package to obtain an identification number of the package to which the information carrier is attached. The input unit creates a message from a user. The processor converts the identification number into a first signal and converts the message into a second signal. The first communication unit transmits the first signal and the second signal to the portable electronic device.

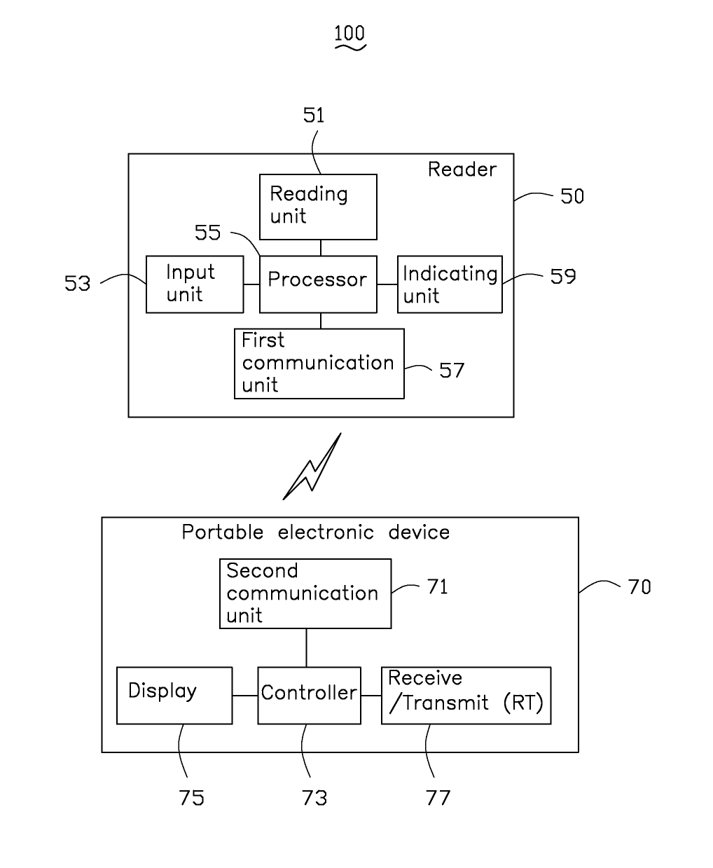

### FIELD

The disclosure generally relates to personal digital assistants (PDAs), and particularly relates to a reader and information processing system using the same.

### BACKGROUND

Readers are commonly used in business to read information carriers, such as barcodes, matrix codes, and RFID tags. A reader may be integrated in a portable electronic device and can obtain an identification number of an object to which an information carrier is attached. Additionally, related information (for example, destination or telephone numbers) can be edited using the portable electronic device, and then the identification number and the related information can be sent to a terminal server. However, such a reader can present reinstallation or removal problems in the event of malfunction.

### BRIEF DESCRIPTION OF THE DRAWINGS

Implementations of the present technology will now be described, by way of example only, with reference to the attached FIGURE.

The FIGURE is a block diagram of an information processing system employing a reader, according to an exemplary embodiment.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawing is not necessarily to scale and the proportions of certain parts may be exaggerated to better illustrate details and features of the present disclosure.

A definition that applies throughout this disclosure will now be presented.

The term “comprising,” when utilized, means “including, but not necessarily limited to”; it specifically indicates open-ended inclusion or membership in the so-described combination, group, series and the like.

The present disclosure is described in relation to a reader and an information processing system using the same.

The FIGURE illustrates an embodiment of a reader 50, according to an exemplary embodiment. The reader 50 is employed in an information processing system 100 to read information carriers, such as barcodes, two-dimension codes, or radio frequency identification (RFID) tags on an object such as a package bill to obtain identification number such as a package serial number. The information processing system 100 further includes a portable electronic device 70 separated from but communicating with the reader 50. The portable electronic device 70 can be a mobile phone, a tablet, or an intelligent watch, for example (details are not shown).

The reader 50 includes a reading unit 51, an input unit 53, a processor 55, a first communication unit 57, and an indicating unit 59. All of the reading unit 51, the input unit 53, the first communication unit 57, and the indication unit 59 are electronically connected to the processor 55. The reading unit 51 reads the information carriers, such as barcodes, two-dimension codes, or RFID tags to obtain the identification number. In at least one embodiment, the reading unit 51 can be an infrared scanner or a radio frequency (RF) antenna, which is operated at a high frequency mode, an ultra high frequency mode, or around a central frequency of about 2.4 GHz. The input unit 53 can be a physical keyboard or a virtual keyboard, used to create a message (data) including related package information (for example, destination or telephone numbers).

The processor 55 receives the identification number from the reading unit 51, and converts the identification number into a first signal. In addition, the processor 55 receives the massage from the input unit 53, and converts the message into a second signal. The first communication unit 57 transmits the first signal and the second signal to the portable electronic device 70. The indicating unit 59 indicates whether or not the reading unit 51 does obtain the identification number. If the reading unit 51 does obtain the identification number, the processor 55 turns on the indicating unit 59, and controls the reading unit 51 to enter a sleep mode to conserve power. If the reading unit 51 does not obtain the identification number, the processor 55 turns off the indicating unit 59, and controls the reading unit 51 to continue to read the information carrier. In at least one embodiment, the indicating unit 59 can be a buzzer or a light emitting diode (LED).

The portable electronic device 70 includes a second communication unit 71, a controller 73, a display 75, and a receive/transmit (RT) unit 77. All of the second communication unit 71, the display 75, and the RT unit 77 are electronically connected to the controller 73. The second communication unit 71 communicates with the first communication unit 57 to receive the first signal and the second signal. The controller 73 converts the first signal and the second signal into a first display signal and a second display signal, respectively. Thus, the first display signal and the second display signal can be displayed on the display 75 to facilitate checking Additionally, the controller 73 is configured to edit the second signal by adding the first signal to obtain a third signal. The RT unit 77 transmits the third signal to a server located at a warehouse.

In at least one embodiment, the first communication unit 57 and the second communication unit 71 can be a near field communication unit, such as a BLUETOOTH® unit or a wireless fidelity (WIFI®) unit, for example. The RT unit 77 can be a general packet radio service (GPRS) unit.

In use, the reader 50 is actuated to read the information carrier by the reading unit 51 to obtain the identification number. The processor 55 converts the identification number into the first signal, and then the first signal is transmitted to the portable electronic device 70 to be displayed on the display 75. In addition, the message is created by the input unit 53, and is converted into the second signal. The second signal is transmitted to the portable electronic device 70 to be synchronously displayed on the display 75. Finally, the controller 73 adds the first signal to the second signal to obtain the third signal. That is, the identification number including the serial number is associated with the message including related package information. The RT unit 77 transmits the third signal to the server, thereby uploading the identification number and the message to the server.

In other embodiments, the reader 50 and the portable electronic device 70 are interconnected by wires, for example, an audio cable. At this time, the data transmission between the reader 50 and the portable electronic device 70 can be achieved through the wires.

In summary, the reader 50 is separated from the portable electronic device 70. Thus, both the reader 50 and the portable electronic device 70 can be easily changed when one of them malfunctions or needs to be upgraded. Additionally, the reading of an information carrier by the reader 50 and inputting a message into the portable electronic device 70 can be simultaneously implemented. Therefore, the data read-write assembly 100 is both efficient and convenient.

The embodiments shown and described above are only examples. Many details are often found in the art such as the other features of the case and the data read-write assembly using the same. Therefore, many such details are neither shown nor described. Even though numerous characteristics and advantages of the present technology have been set forth in the foregoing description, together with details of the structure and function of the present disclosure, the disclosure is illustrative only, and changes may be made in the details, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A reader in communication with a portable electronic device, the reader comprising:
a reading unit reading an information carrier to obtain an identification number of an object to which the information carrier is attached;
an input unit which creates a message;
a processor which converts the identification number into a first signal and converts the message into a second signal; and
a first communication unit which transmits the first signal and the second signal to the portable electronic device.

2. The reader as claimed in claim 1, wherein the input unit is one of a physical keyboard and a virtual keyboard.

3. The reader as claimed in claim 1, further comprising an indicating unit, wherein the indicating unit indicates whether or not the reading unit obtains the identification number, if the reading unit obtains the identification number, the processor turns on the indicating unit, and controls the reading unit to enter a sleep mode to conserve power, if the reading unit does not obtain the identification number, the processor turns off the indicating unit, and controls the reading unit to continue to read.

4. The reader as claimed in claim 3, wherein the indicating unit is a buzzer or a light emitting diode (LED).

5. An information processing system comprising a reader and a portable electronic device separated from and communicating with the reader, the reader comprising:
a reading unit reading an information carrier to obtain an identification number of an object to which the information carrier is attached;
an input unit creating a message;
a processor converting the identification number into a first signal and converting the message into a second signal; and
a first communication unit transmitting the first signal and the second signal to the portable electronic device;
wherein the portable electronic device edits the second signal by adding the first signal to obtain a third signal to allow the identification number to be associated with the message.

6. The information processing system as claimed in claim 5, wherein the reader further comprises an indicating unit, the indicating unit indicates whether or not the reading unit obtains the identification number, if the reading unit obtains the identification number, the processor turns on the indicating unit, and controls the reading unit to enter a sleep mode to conserve power, if the reading unit does not obtain the identification number, the processor turns off the indicating unit, and controls the reading unit to continue to read.

7. The information processing system as claimed in claim 5, wherein the portable electronic device comprises a second communication unit, the second communication unit communicates with the first communication unit to receive the first signal and the second signal.

8. The information processing system as claimed in claim 5, wherein the portable electronic device comprises a controller and a display, the controller converts the first signal and the second signal into a first display signal and a second display signal, respectively, and the display displays the first display signal and the second display signal.

9. The information processing system as claimed in claim 5, wherein the portable electronic device comprises a receive/transmit (RT) unit for transmitting the third signal.

10. The information processing system as claimed in claim 7, wherein both the first communication unit and the second communication unit are BLUETOOTH® units or wireless fidelity (WIFI®) units.

11. The information processing system as claimed in claim 9, wherein the RT unit is a general packet radio service (GPRS) unit.
